(19) United States
(12) Patent Application Publication
(10) Pub. No.: US 2009/0012940 A1
(43) Pub. Date: Jan. 8, 2009

(54) SHARING MOBILE SEARCH RESULTS

(75) Inventors: Stephen Ives, Swavesey (GB); Stefan Butlin, Cambridge (GB)

Correspondence Address: BARNES & THORNBURG LLP, P.O. BOX 2786, CHICAGO, IL, 60690-2786, US

(73) Assignee: TAPTU LTD., Cambridge (GB)

(21) Appl. No.: 12/147,619

(22) Filed: Jun. 27, 2008

Related U.S. Application Data
(60) Provisional application No. 60/946,731, filed on Jun. 28, 2007.
(60) Provisional application No. 60/946,727, filed on Jun. 28, 2007.
(60) Provisional application No. 61/019,608, filed on Jan. 8, 2008.
(60) Provisional application No. 61/019,611, filed on Jan. 8, 2008.

(51) Int. Cl. G06F 17/30

(52) U.S. Cl. 707/3; 707/E17.014

(57) ABSTRACT

At least some embodiments of this invention provide for an easy way to share mobile content found as a result of searching and/or browsing on the Internet. Aspects of the invention provides software, systems (meaning software and hardware to run the software) or an exchange of signals with users to provide a mobile content service. Other related aspects provide methods for providing or using such a search service. According to one aspect there is provided a system to provide a search service for finding and sharing online content, the system being arranged to receive a search query from a user on a mobile device, send search results to a user's mobile device, prompt the user to select one or more items from the search results to be published, and publish the selected item or items. Publishing includes sending the selected item or items to a recipient associated with a share link configured by a user, to a user's public stream of results which is visible to any user, to a user's private stream which is visible only to the user or to nominated friends and/or as an electronic greeting to another user. The system may also be arranged to provide to a user sending instructions explaining how to publish the selected search results to a third party recipient using the messaging function of the mobile device but not to send the sending instructions to the third party recipient without the sending instructions.

### RELATED APPLICATIONS

This application claims the benefit of four earlier filed provisional applications, namely Ser. No. 60/946,731 filed Jun. 28, 2007 entitled “Festive Mobile Search Results”; Ser. No. 60/946,727 filed Jun. 28, 2007 entitled “Managing Mobile Search Results”; Ser. No. 61/019,608 filed Jan. 8, 2008 entitled “Method of Convenient Mobile Search Result Sharing” and Ser. No. 61/019,611 filed Jan. 8, 2008 entitled “Method of Sharing Mobile Search Results using Device Messaging Functionality”.

This application also relates to five earlier US patent applications, namely Ser. No. 11/189,312 filed 26 Jul. 2005, published as US 2007/00278329, entitled “processing and sending search results over a wireless network to a mobile device”; Ser. No. 11/232,591, filed Sep. 22, 2005, published as US 2007/0067267 entitled “Systems and methods for managing the display of sponsored links together with search results in a search engine system” claiming priority from UK patent application no. GB0519256.2 of Sep. 21, 2005, published as GB2430507; Ser. No. 11/248,073, filed 11 Oct. 2005, published as US 2007/0067304, entitled “Search using changes in prevalence of content items on the web”; Ser. No. 11/289,078, filed 29 Nov. 2005, published as US 2007/0067305 entitled “Display of search results on mobile device browser with background process”; and U.S. Ser. No. 11/369,025, filed 6 Mar. 2006, published as US2007/0208704 entitled “Packaged mobile search results”. This application also relates to U.S. provisional applications Ser. No. 60/946,729 filed Jun. 28, 2007 entitled “Method of Enhancing Availability of Mobile Search Results”, Ser. No. 60/946,730, filed Jun. 28, 2007 entitled “Social distance search ranking”, Ser. No. 60/946,728, filed Jun. 28, 2007 entitled “Ranking Search Results Using a Measure of Buzz”, and Ser. No. 60/946,726, filed Jun. 28, 2007 entitled “Audio Thumbnails”.

The contents of these applications are hereby incorporated by reference in their entirety.

### FIELD OF THE INVENTION

This invention relates to query servers for providing a mobile search service, to corresponding methods of using a mobile search service, and corresponding apparatus and software.

### DESCRIPTION OF THE RELATED ART

Search engines are known for retrieving a list of addresses of documents on the Web relevant to a search keyword or keywords. A search engine is typically a remotely accessible software program which indexes Internet addresses (universal resource locators (“URLs”), usenet, file transfer protocols (“FTPs”), image locations, etc). The list of addresses is typically a list of “hyperlinks” or Internet addresses of information from an index in response to a query. A user query may include a keyword, a list of keywords or a structured query expression, such as Boolean query.

A typical search engine “crawls” the Web by performing a search of the connected computers that store the information and makes a copy of the information in a “web mirror”. This has an index of the keywords in the documents. As any one keyword in the index may be present in hundreds of documents, the index will have for each keyword a list of pointers to these documents, and some way of ranking them by relevance. The documents are ranked by various measures referred to as relevance, usefulness, or value measures. A metasearch engine accepts a search query, sends the query (possibly transformed) to one or more regular search engines, and collects and processes the responses from the regular search engines in order to present a list of documents to the user.

It is known to rank hypertext pages based on intrinsic and extrinsic ranks of the pages based on content and connectivity analysis. Connectivity here means hypertext links to the given page from other pages, called “backlinks” or “inbound links”. These can be weighted by quantity and quality, such as the popularity of the pages having these links. PageRank™ is a static ranking of web pages used as the core of the search engine known by the trademark Google (http://www.google.com).

Search engines for searching the world wide web are well developed for accessing the web from a desktop personal computer (e.g. Google, Yahoo, et al). Mobile devices that are capable of accessing content on the world wide web are being increasingly numerous. Mobile search engines prompt the user for a search term (or terms) and return mobile search results that are currently limited to links to mobile-specific websites and transcoded (automatically adapted) desktop websites. However, mobile web pages designed specifically for the small screen sizes of mobile devices are very few. A mobile web page is defined as a website whose content is rendered using HTML that can be reasonably viewed and navigated within the constrained display and network capabilities of a hand held mobile device or handset. Furthermore, there are only a few very simple search services available to mobile devices. These mobile search services perform poorly for several reasons:

there are not enough mobile-specific pages available to provide relevant pages for most search queries, compared to the number of desktop webpages,

desktop-specific webpages cannot be easily rendered on the limited screen and limited browsers of mobile devices, and

direct translation of desktop-specific webpages to the specific markup language supported by most mobile devices (eg XHTML Basic and XHTML Mobile Profile) is a hard problem, so the number of desktop websites that are successfully adapted by a transcoder is small.

Mobile search engines struggle with the limited amount of mobile content that exists to be indexed. Users of mobile handsets in turn struggle to find entertaining or useful mobile content. Further, in many situations, search results presented to a user on a mobile device cannot be viewed or utilised due to the limited capabilities of the mobile device's screen and network.

Some of these problems are addressed in US 2007/00278329, US 2007/0067267, US 2007/0067304, US 2007/0067305 and US2007/0208704 to the present applicants and the contents of these applications are herein incorporated by reference. The present applicant has realized that further improvements are possible.

### SUMMARY OF THE INVENTION

Amongst others, an aim of the invention is to provide means to share information from the Internet, including interesting search results and/or website addresses, e.g. with other users or in a user's own archive. According to one aspect there is provided a system to provide a search service for finding and sharing online content, the system being arranged to receive a search query from a user on a mobile device, send search results to a user's mobile device, prompt the user to select one or more items from the search results to be published, and publish the selected item or items. Publishing includes sending the selected item or items to a recipient associated with a share link configured by a user, to a user's public stream of results which is visible to any user, to a user's private stream which is visible only to the user or to nominated friends and/or as an electronic greeting to another user. The system may also be arranged to provide to a user sending instructions explaining how to publish the selected search results to a third party recipient using the messaging function of the mobile device but not to send the sending instructions to the third party recipient without the sending instructions.

Various aspects of the invention are set out in the independent claims. Any additional features can be added, and any of the additional features can be combined together and combined with any of the above aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows schematically an overview of some of the principal entities involved in an embodiment of the invention,

FIG. 2a shows a schematic view of a screenview including a user interface prompting a user to share displayed search results,

FIG. 2b shows a schematic view of a screenview displaying some shared search results,

FIG. 3 shows a flowchart of the steps for a user to share search results;

FIG. 4 shows schematically an overview of some of the principal entities involved in another embodiment of the invention,

FIGS. 5a and 5b show schematic views of a screenview including a user interface having multiple links to share displayed search results,

FIG. 6 shows a flowchart of the steps for a user to share search results using this embodiment;

FIG. 7 shows schematically an overview of some of the principal entities involved in another embodiment of the invention,

FIG. 8a shows a schematic view of a screenview displaying search results to be shared,

FIG. 8b shows a flowchart of the steps for a user to share search results using this embodiment;

FIG. 9 shows schematically an overview of some of the principal entities involved in another embodiment of the invention;

FIG. 10 shows a schematic view of a screenview displaying search results to be published in an electronic greetings card, and

FIG. 11 shows a flowchart of the steps for a user to share search results using this embodiment.

### DETAILED DESCRIPTION

### Definitions

Online means accessible by computer over a network and so can encompass accessible via the internet or public telecommunications networks, or via private networks such as corporate intranets.

Content items encompasses web pages, or extracts of web pages, or programs or files such as images, video files, audio files, text files, or parts of or combinations of any of these and so on.

User can encompass human users or services such as meta search services.

Items which are “accessible online” are defined to encompass at least items in pages on websites of the world wide web, items in the deep web (e.g. databases of items accessible by queries through a web page), items available internal company intranets, or any online database including online vendors and marketplaces.

Hyperlinks are intended to encompass hypertext, buttons, softkeys or menus or navigation bars or any displayed indication or audible prompt which can be selected by a user to present different content.

The term “comprising” is used as an open-ended term, not to exclude further items as well as those listed.

### Introduction to Embodiments:

At least some embodiments of this invention provide for an easy way to share mobile content found as a result of searching and/or browsing on the Internet. Aspects of the invention provides software, systems (meaning software and hardware to run the software) or an exchange of signals with users to provide a mobile content service. Other related aspects provide methods for using such a mobile content service.

One aspect of the invention provides software, systems (meaning software and hardware to run the software) or an exchange of signals with users, to provide a search service for finding online content, arranged to send search results to a user, and prompt the user to select one or more items from the search results, the service also being arranged to make the selected item or items publicly available as being recommended by the user.

Another aspect provides a method of using such a service, by sending a search query, receiving search results, selecting one or more items from the search results, causing the service to make the selected item or items publicly available as being recommended by the user.

Another aspect provides software, systems (meaning software and hardware to run the software) or an exchange of signals with users, to provide a search service for finding online content, arranged to send search results to a user, and prompt the user to select one or more items from the search results, the service also being arranged to make the selected item or items privately available. The service also prompting users to nominate other users as friends (or other types of association) and where the privacy of selected search results can mean either availability for just that user or just that users nominated friends.

In the above aspects, making selected results available, whether publicly or privately, can be achieved in a number of ways, some of which are described below.

Another aspect of the invention provides software, systems (meaning software and hardware to run the software) or an exchange of signals with users, to provide a search service for finding online content, arranged to send search results to a user, and prompt the user to select one or more items from the search results, the service also being arranged to incorporate the selected item or items into an electronic greeting, for sending to another person.

Another aspect provides a method of using such a service, by sending a search query, receiving search results, selecting one or more items from the search results, causing the service to incorporate the selected items into an electronic greeting, and causing the electronic greeting to be sent to another person

These aspects provide an easy way to generate and send a mobile-friendly electronic greeting. Sending can involve sending the greeting directly, or sending indirectly by sending an address or other pointer to where the greeting can be accessed by the recipient.

### DETAILED DESCRIPTION OF THE DRAWINGS

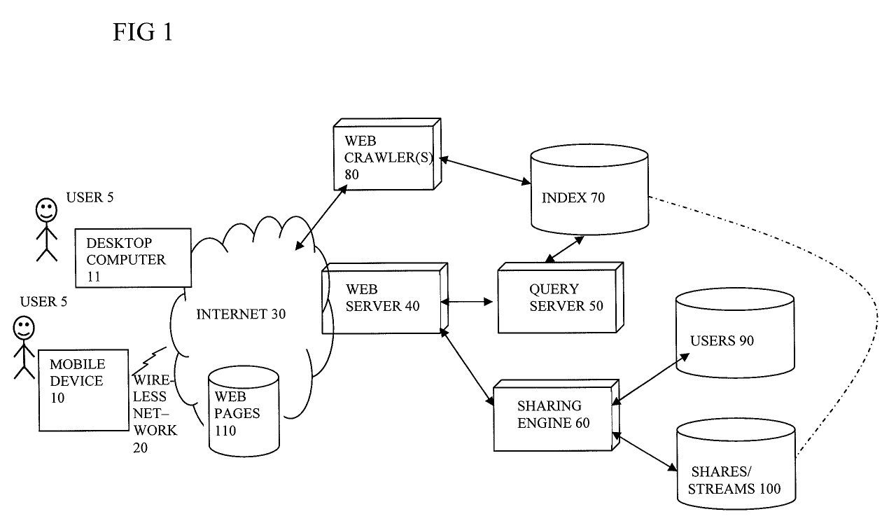

The overall topology of the embodiments of the invention is illustrated in FIGS. 1, 4, 7 and 9. In each embodiment, a mobile search service is deployed using the normal components of a search engine. Thus a front-end query server 50 and a back-end web crawler 80 are connected to the Internet 30 via a web server 40. The web crawler spiders the World Wide Web to access web pages 110 and typically builds up a web mirror database (not shown) of locally-cached web pages. An index server (not shown) builds an index 70 of the web pages from this web mirror. This system can be formed of many servers and databases distributed across a network, or in principle they can be consolidated at a single location or machine. The term search engine can refer to the front end, which is the query server in this case, and some, all or none of the back end parts used by the query server, whose functions can be replaced with calls to external services.

A plurality of users 5 connected to the Internet via desktop computers 11 or mobile devices 10 can make searches via the query server. The users making searches (‘mobile users’) on mobile devices are connected to a wireless network 20 managed by a network operator, which is in turn connected to the Internet via a WAP gateway, IP router or other similar device (not shown explicitly). The search results sent to the users by the query server can be tailored to preferences of the user or to characteristics of their device.

The first depicted aspect of the invention aims to provide an easy way to share mobile content found as a result of searching. Thus, as shown in FIG. 1, the query server 50 is also connected to a sharing engine 60 having one or more databases to store registered users and streams of published search results. A first user database 90 stores information on the users, e.g. individual user profile information, or individual profiles aggregated into group profiles, so that the service can be personalised to individual user or group needs. This may or may not include usage history information. A second stream database 100 stores shares/streams which have been published as explained in more detail below. Although shown as two databases, these databases may be implemented as a single database.

The query server provides for user login. The user is identified by registering a username and password and then subsequently by logging in with the same username and password. The registration process is a one-time process per user. In a preferred embodiment, the login process is also a one-time process per user by caching their credentials (or a unique key representing their identity) in a cookie. However, where cookies are not supported then the user is required to provide username and password per result publication. The user could be required to login at the first page of the mobile search service, however, in the preferred embodiment, the user is only prompted for login (if not already identified) when first attempting to publish a result.

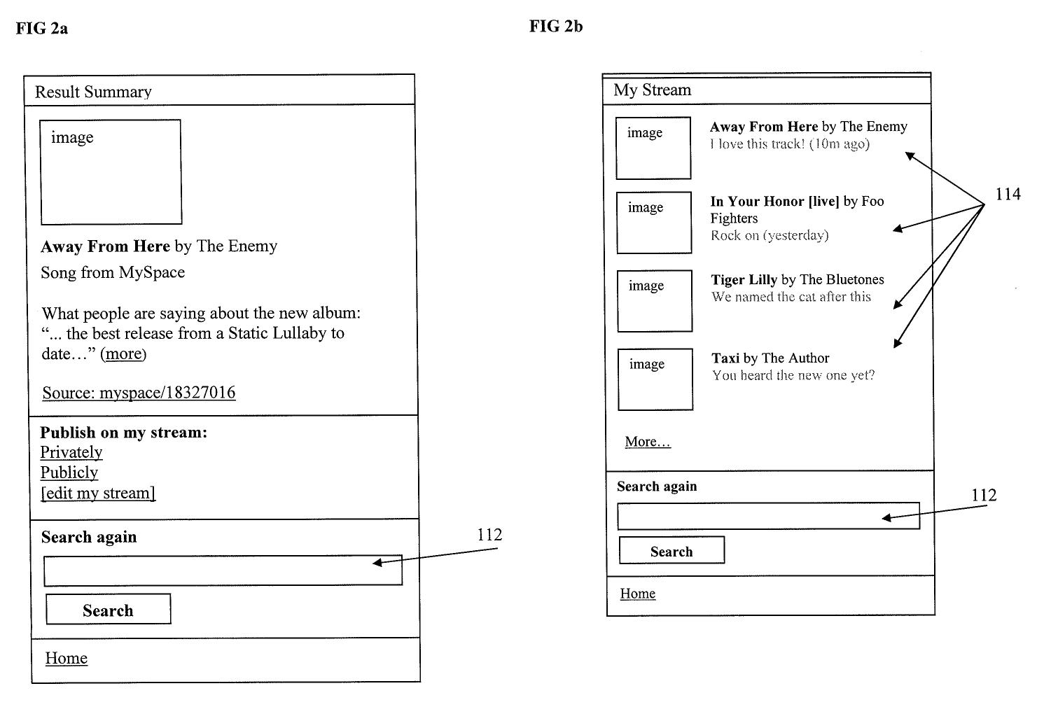

FIG. 2a shows an example screenview on a mobile device showing a result summary from a search result. The query server has augmented the presentation of the search result with a “publish this” link. The exact labelling of this link is an aesthetic decision and could be any of “publish this”, “recommend result”, “I like it”, “save in stream” and so on. In FIG. 2a, the phrase “publish on my stream” is used with the sub-heading “privately”, “publicly” and “edit my stream”. Thus, the screenview is providing a user interface to allow a user to select how to share results.

Private publication of results could be implemented as adding a result to a users stream such that the result is only visible in the stream to that user—other users would simply see the rest of the stream. Private publication could also mean publishing to a users private stream as distinct to a users public stream. Private publication could also be implemented as the limited publication to nominated users only (i.e. friends). Public publication of results is implemented as adding results to a users stream that can be viewed by any user whether identified (logged in) or not. For the group privacy implementation, the concept of users friends is added. Friends are declared by a user thus enabling those declared users access to view items published as private.

Once the “privately” or “publicly” option is selected, a user may be taken to another user interface offering additional options. For example, a user may publish to multiple streams. A user can identify the name (or alias) of any of their streams. Each stream can be given its own privacy settings and have its own list of declared friends. Streams may be associated with multiple users—a group stream. Such group streams can be published to by either only their declared members or, if public, by any user.

As shown in FIG. 2a, the search result comprises an image, a title, a summary description and a link to the source site. As an alternative, search results may be presented as a list of links where the links take the user to a richer summary of the result rather than the real result destination. This provides the user with more information to ascertain the relevance of the result and yet still maintaining the context of the current search term (which might be lost if the user were taken directly off to the destination site). Such an arrangement would allow for the “publish this” link to appear on the richer summary page rather than attempt to squash it onto the first result list which is already cramped for space on a small mobile display.

In yet another alternative, search results may be presented as a list of links where the links take the user to a proxied view of the destination site. The proxy is implemented by the host mobile search service and allows the search service to alter the destination result page by adding a (preferably small) menu bar at the top (and/or bottom) of the result page. This banner can be used to both maintain the context of the current search term and provide the “publish this” link. In addition, as shown in FIG. 2a, the banner could provide an additional search box 112 for fast entry (no further browsing to the service home page) of a new search term.

Results which are published are associated with the user (the “publisher”) and treated as a stream of search results emanating from that user. The option “edit my stream” shown in FIG. 2a presents a user with his associated stream. This stream can be viewed on both desktop and mobile interfaces of the service. FIG. 2b shows an example of a preferred embodiment showing a desktop version of a front-end interface for the mobile device. The interface provides a means to view one or more streams or combinations (mixes) of streams. As shown, the stream is displayed as a vertical list of search results 110. Only single result items that have been published appear in the list. Other search results related to the original query term are not present. The list is preferably scrollable and is preferably sorted in date order with the most recently published results at the top.

The user interface on which the stream is displayed also comprises an additional search box 112 for fast entry for a user to enter a new search term and begin a new search. Alternatively, a user may select the “home” hyperlink to restart the application.

Depending on the privacy settings of the stream, a stream may be viewed by the publishing user as well as other users. This has several benefits:
results can be moved to a users desktop context where the content might be more easily consumed with the increased display, network and/or processing capabilities of desktop computers.
Results are therefore archived for viewing again at a later date, whether via the mobile or desktop interface
Results that have been published by one user are very likely to be items that other users would also be interested in, especially users that are friends of the publisher. One interpretation of the stream is that the results are recommended results.

As explained previously, a typical search engine “crawls” the Web and makes a copy of the information in a “web mirror” having an index of the keywords in the documents. The documents are ranked by various measures referred to as relevance, usefulness, or value measures. US 2007/0067304 entitled “Search using changes in prevalence of content items on the web” to the present applicant describes one method of ranking the documents. Statistics about the publication of search results can be used to assist search relevancy. A content item that is frequently published is likely to be more relevant to future users searches than a content item that is infrequently published. This idea can then be further extended to include consideration of who published search results—search results published by friends (or friends of friends to a slightly lesser degree, and so on for friends of friends of friends) are likely to be more relevant to a user than search results published by someone unconnected in the resulting “social network”.

In FIG. 2b, each item 110 in the list is a single search result. The representation of a search result is the content items main title, a summary description and other optional meta data such as links to the source site, links to related items, links to re-perform the search which produced the item and so on. In this preferred embodiment, each result row in the stream list includes an image, a title, a description and a link to the online content which the result is representing.

The embodiment of FIG. 2b may be further extended to provide for the tagging of published results with one or more keywords. This tagging could be implemented as both an optional requirement or a compulsory requirement. The tags or keywords supplied can then be associated with the search result as additional meta-data for use in future searches. In one implementation, these tags might be used for all future users searches, however, this idea would be easy to abuse (search result gaming). Instead then, the tags could be conditionally included in the search index for searches conducted by the publisher and/or their friends or friends of friends (to a lesser degree etc). Where a search result is publish by multiple users, especially where those users are socially distant (not close in the social network of friends of friends), any matching keywords can be treated as having a higher statistical significance.

It is also possible to augment the publication of search results with the general submission of arbitrary user-generated content. This may be achieved as described in co-pending PCT application to the present applicant claiming priority from U.S. provisional application 60/946,729. This may allow the user to mix the convenient publication of search results with so-called “micro blogging”. User generated content, depending on its privacy settings, could then be used to augment the search index and further enhance the quantity of mobile-friendly content available to the search engine.

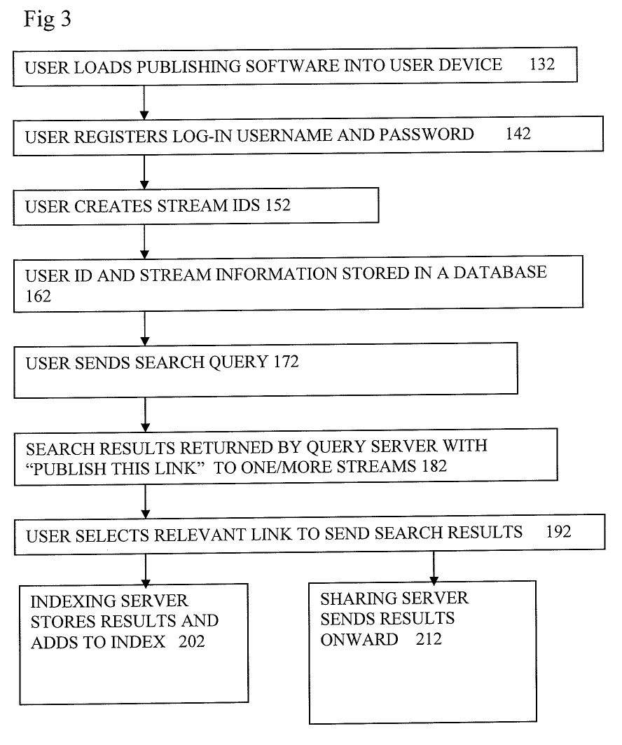

FIG. 3 summarises the main steps in this method of sharing results. At step 132, a user loads the publishing software into the user device (generally a mobile device). At a first stage, the user registers a log-in username and password (step 142) and creates streams (step 152). As explained above, the streams may be public or private and may publish to one or more individual. The log-in information and stream information is stored in a database for later use by the sharing engine. After the initial set-up, the sharing engine prompts a user to log-in so that stream information relevant to that user may be accessed by the sharing engine. The user then sends a search query (step 172) and the search results are returned by the query server with the “publish this link” (step 182). The user selects the relevant link (step 192) and the sharing server sends the results to the appropriate stream (step 212). The indexing server may also store the published search results and add them to the index (step 202).

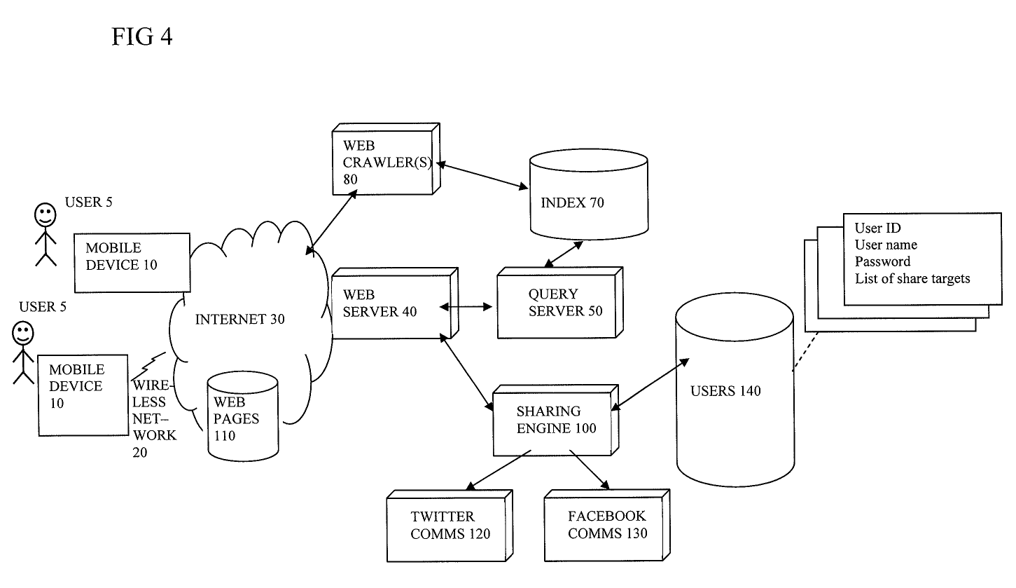

FIG. 4 shows the overall topology of a second embodiment of the invention which is has many features in common with the topology illustrated in FIG. 1. The features having the same reference numbers as FIG. 1 behave in a similar manner. As in FIG. 1, the embodiment of FIG. 4 uses the normal components of a search engine and is augmented with a sharing engine 110 connected to a database 140 holding user-account information such that users of the service can register and configure their preferences. In this embodiment, the user database 140 comprises information including user ID, user name, password and list of share targets.

As in the previous embodiment, the query server provides for user login. The user is identified by registering a username and password (create an account) and then subsequently by logging in with the same username and password. Users configure the share targets by defining a list of 3^{rd} party recipients. The configuration of each recipient should include an on-screen alias for that person, the messaging method and relevant associated contact information (e.g. phone number for SMS, email address for emails etc) and can also include some text to be sent with every share message. Each recipient can be established manually (recipient by recipient) or might be initialised with a bulk import from a 3^{rd} party service such as email addresses from Google's Gmail.

The recipients do not have to be individuals at an email or SMS address. Instead, the service could be arranged to provide for integration with 3^{rd} party social network sites such as Facebook or MySpace. The sharing engine 110 is thus provided with means for communicating with such sites, e.g. twitter communications 120 or facebook communications 130. In such situations, the contact details for the recipient would be the relevant Facebook or MySpace account identifiers and the message would be a Facebook- or MySpace-specific messaging service.

Recipients do not have to be a single individual. Instead, a single share target could be configured to instantly share to a group of recipients (of perhaps heterogeneous messaging methods).

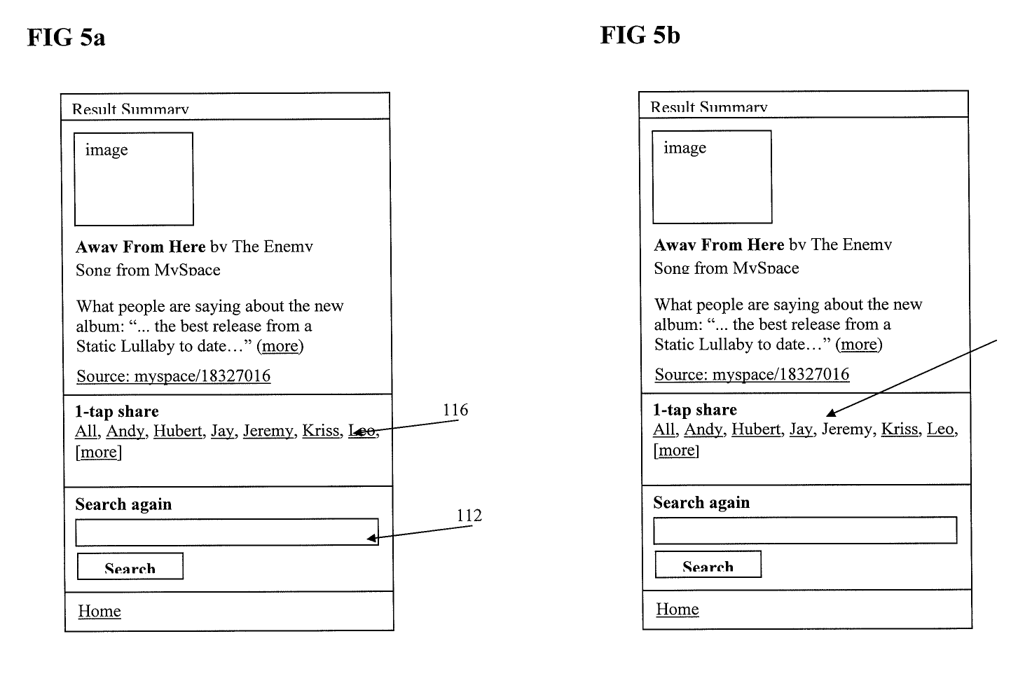

FIG. 5a shows an example screenview on a mobile device showing a result summary from a search result. The query server has augmented the presentation of the search result with a list of share links 16. Thus, as before the screenview provides a user interface to allow a user to share search results. Each share link is associated with someone that the current user might like to share a result with. When these links are clicked on, the query server looks up the pre-configured share details for that link (who to share the result with and by what method), sends the appropriate message to the appropriate destination, and returns the user to the same page they were already looking at. A confirmation message indicating the result has been shared to the requested 3^{rd} party may also be sent. Further, as shown in FIG. 5b, the share link 118 that was just clicked on can be greyed out to reduce the chance of repeating the share of the same result to the same 3^{rd} party.

As will be appreciated, this aspect of the invention reduces the number of clicks required to share a search result on a mobile device to a single click and thus this aspect may be termed a “one-tap share” link method. In contrast, other existing methods for sharing involve multiple key presses and/or cursor/mouse navigation through one or more menus of options. On a mobile handset native messaging functionality may be used for sharing. This involves the user being told to use these menus and then making multiple menu selections to navigate through the user interface and eventually send a message containing a link to the current URL. Another existing method on desktop web browsers involves installing plug-ins for the browser (e.g. Firefox, or MS Internet Explorer) that offer more menus of options tailored to choosing and sending the current URL to another user. However such plug-in based solutions are not possible on most mobile devices due to the limited and mostly-closed nature of the web browser applications. On a desktop browser, keyboard and mouse input are fast and convenient and there is no real problem. However, on a mobile device, the web browser and its input methods (typically only a numeric keypad and cursor navigation) are much more constrained and the operations required to share a page (or search result) with another user take non-trivial amounts of time. Accordingly, this aspect of the invention offers a real advantage over existing technologies.

In FIGS. 5a and 5b, the list of share links is provided on a one-page summary of a search result. Such summary pages may be created (or packaged) as described in US 2007/00278329, US 2007/0067305 or US2007/0208704 to the present applicants. When search results are returned on the mobile device, each result in a list of results is a link, not to the source of that result, but to the one-page summary depicted. As is shown, there is adequate room on such summary pages to provide a list of share links. Alternatively, the list of share links can be located visually nearby each search result in a list of search results which is returned without such packaging. The list of share links may be located either visually within the body of the result, or appended immediately after it. It is acknowledged that there may be little room available for multiple share links per search result on a page containing multiple results, and so this aspect of the invention is of particular benefit when used in conjunction with the earlier US applications but is not limited to such teaching.

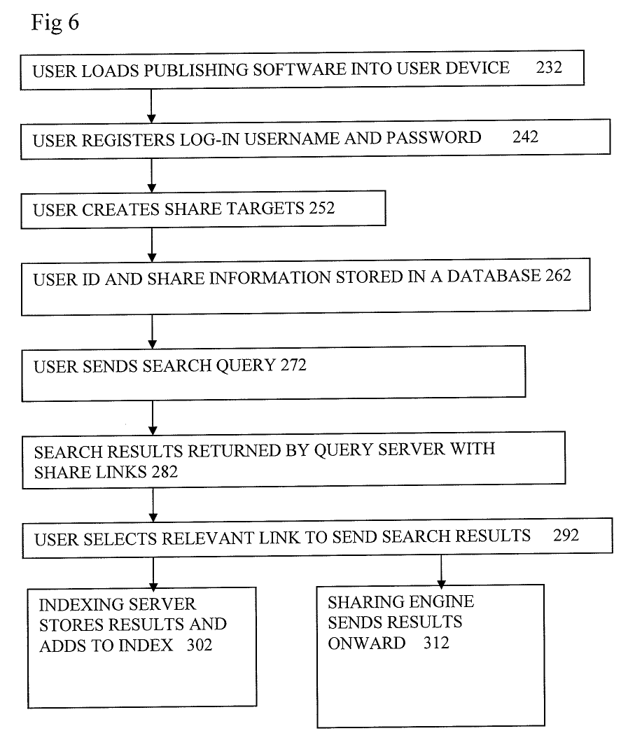

FIG. 6 summarises the main steps in this method of sharing results. At step 232, a user loads the publishing software into the user device (generally a mobile device). At a first stage, the user registers a log-in username and password (step 242) and creates share targets (step 252). The log-in information and share information is stored in a database for later use by the sharing engine. After the initial set-up, the sharing engine prompts a user to log-in so that share information relevant to that user may be accessed by the sharing engine. The user sends a search query (step 272) and the search results are returned by the query server with a list of share links (step 282). The user selects the relevant link (step 292) and the sharing server sends the results to the appropriate target (step 312). The indexing server may also store the published search results and add them to the index (step 302).

In another embodiment of the invention, the same service as described above is deployed and enhanced with the additional feature of supporting user accounts such that the destination of a share link can be another users account within the same service. This means that recipients of shared results (when they are logged in) can be notified of new shares and access those shares from within the same user interface as the rest of the search service. Further, if another user does not yet have an account on the system, the system can make a temporary account, store the shared item (or meta-data about the shared item) in this temporary account, and then send the user another message type (e.g. email or SMS) to notify them (in effect, inviting them to join) that an item has been shared. To achieve this arrangement, the sender must be able to configure a share link that specifies both another user account (which might not exist yet) and an address (e.g. email) at which they can be notified if necessary.

As explained above, most handsets are equipped with messaging functionality that is accessible from the web browser application on the handset. Typically, such functionality is accessed using an “options” menu and then via a menu item labelled “send bookmark” or equivalent. The user can then send the URL of the current web page (the page the web browser is currently displaying) using the native SMS, MMS, Email or any other messaging service available to the particular handset. However, many users are unaware of such functionality. This may be overcome by using the “one-tap share” link described above. As an alternative, the system may generate a helpful user interface to provide instructions, at least to first-time users, in how to achieve this method of sharing the current page.

However, there is an additional problem with such a solution, namely that the current URL is the item that is being shared and this URL is being viewed by both sender and receiver. This additional problem may simply be ignored; either by displaying the instructions to both sender and receiver, or by displaying the normal (no instructions) view to both parties with perhaps a link to a help page (although visible to both sender and receiver).

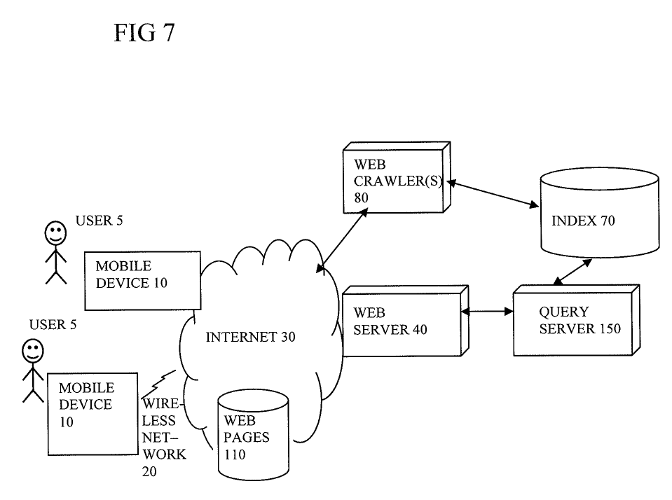

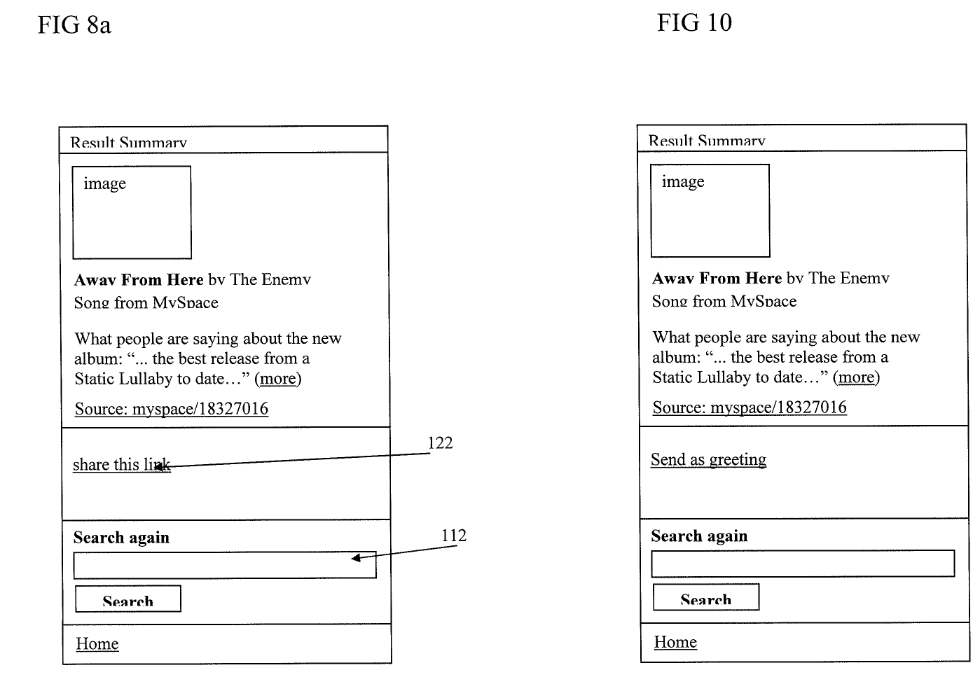

FIG. 7 shows the overall topology of another embodiment of the invention which addresses this problem. Unlike previous embodiments, there is no sharing engine, simply the normal components of a search engine. As shown in FIG. 8a, each search result is augmented with an additional share link. As in FIGS. 5a and 5b, the share link is provided on a one-page summary of a search result but may alternatively be provided on a standard list of search results. Although FIG. 8a shows the invention applied to sharing of search results, the invention has applicability to any application on a mobile device where a page identified by a URL needs to be shared using the native messaging functionality of the device.

This share link is the URL that is to be shared and takes the sender (the user attempting to share the current search result) to a page with instructions on how to send it. The URL includes an identifier that is unique to the current instance of sharing a result (i.e. the identifier will be different for the next user to click on the share link for the same search result, even if by the same user as for the first attempt). The query server is arranged to serve a page containing a summary of the search result for this URL, and to also include sending instructions if the combination of page and unique identifier are being viewed for the first time. Thereafter, a flag is associated with that identifier to indicate it has been viewed with instructions and all subsequent requests for that page and identifier will return the normal view of the page (i.e. without instructions). A user receiving a link to the URL will therefore cause his browser to generate at least the second request for that URL and hence receives the normal-view of the relevant page (search result).

In other words, this aspect of the invention displays a version of the page with instructions on it to the sender (the send-view) and to display the normal view of the page to the receiver (normal-view), and the means to do this on a mobile handset where the URL must be the same for both parties and where browser cookie support cannot be relied upon.

Where browser cookie support is available, the method above is used but is also augmented with cookie support when available in the handset. Where cookie support is detected, the unique identifier is used to associate the instance of sharing with the sender (as identified using a user-unique identifier stored in the cookie). When the receiver's handset requests the URL, either there is no cookie sent to the server (if the receiver's handset does not support cookies) or a cookie with a different user ID (i.e. different compared to the sender) is received by the server. This is then sufficient information for the server to elect to serve the normal-view to the receiving user and the send-view to the sending user. The advantage of using cookies when available is that the sender is also displayed the send-view, even if they issue multiple requests for the same page (e.g. by reloading the current page via the “refresh” menu option).

As an alternative to using flags or cookies, the HTTP referrer identified in the HTTP headers contained in the request received from the mobile device's web browser may be used to determine whether a user is a sender or a recipient of a search result. The HTTP referrer is extra meta data and identifies the URL of a previous page viewed by a user. The server may be arranged to read the HTTP referrer and identify whether or not the HTTP referrer is null or empty. If an empty HTTP referrer is identified, this suggests that the user has gone straight to this page and is thus a sender. Accordingly, the server is arranged to send the sending instructions with the search result. If the HTTP referrer is not null, for example a previous page of the search engine, this suggests that the user is a recipient. In these cases, the server is arranged not to send the sending instructions.

FIG. 8b summarises the steps in sharing search results or URL's identified by browsing using the native messaging function of the mobile device. At step 402, a URL is identified (by browsing or by searching as in previous embodiments). A user interface, e.g. banner on a screenview, prompts a user to select to share the URL. The query server serves sending instructions to the user (step 422) and the user follows the sending instructions to send the URL to a recipient (step 432). The query server is arranged to serve the URL without sending instructions to the recipient (step 442). The URL being shared may be reduced to only contain the domain of the search service and the unique “share ID”. The server is then arranged to associate all of the meta-data about that share with a Share ID, including the search result that is being shared, the sender ID if known, the number of times it has been viewed etc. This has the benefit of keeping the URL very short which is advantageous on a mobile device; both to keep the URL looking simple when viewed on a small display and when sending using SMS as the messaging service as SMS messages have a very limited payload of only 165 bytes. If the URL is kept short, the user has more opportunity to add their own message than if the URL is long and takes up all or most of those 165 bytes of available characters.

The content of the instructions displayed to the user is tailored to be accurate for the specific model of handset that the sender is using. For example, on a Nokia device, the send bookmark link is accessed via the “options” menu, whereas on a Sony Ericsson device, it is via the “more” menu. The server is arranged to do this by detecting the user agent identified in the HTTP headers contained in the request received from the handset's web browser. The server then looks up which instructions to use from a database of handset models and their specific instructions.

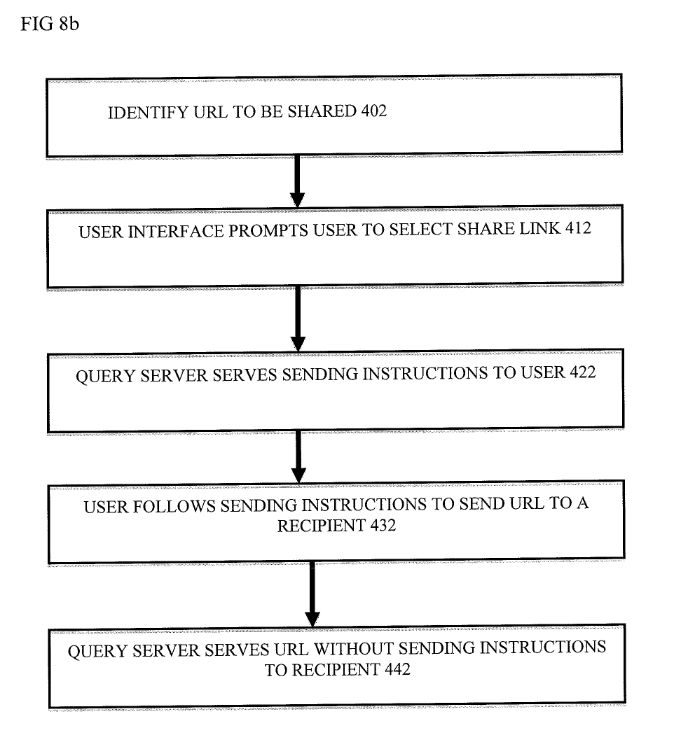

FIG. 9 shows another aspect of the invention which provides an easy way to generate a mobile-friendly electronic greeting by using a customized search engine to find the main content item for the card. Many sites exist for users to construct and send an electronic greeting card. The process of constructing some content for use as a greeting (seasonal or otherwise) is significantly easier on a desktop web interface than a mobile web interface—due to the constrained screen dimensions and limited input capabilities of many mobile devices.

As shown in FIG. 9, a mobile search engine service is augmented with a sharing engine which provides the means to send a search result as the main content of a greeting. The sharing engine is connected to a database storing events and/or a calendar of dates. The sharing engine is also connected to a user database allowing a user to specify preferences, including location, language or other locale settings. The text of the link for the greeting card may be changed according to one or more of several factors taken from either database including:

the time of year

the geographical location of the user

the language the user has selected to view the interface in

the locale settings the user may have set in a settings page

any other settings

Thus the invitation to “send as greeting” can be made more relevant and timely and hence more likely to stimulate the user into using this service.

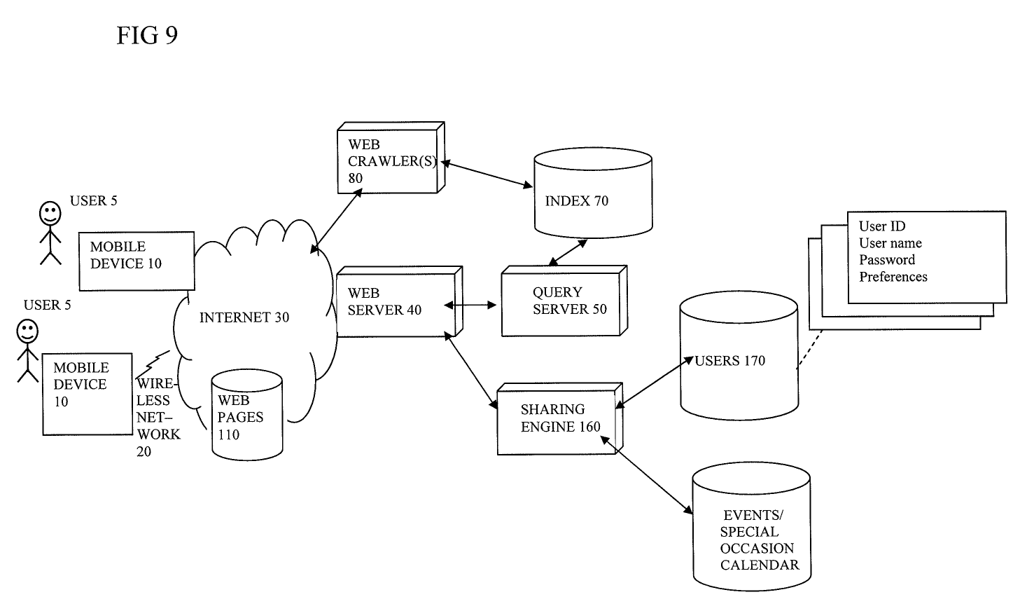

A user performs one or more searches until a suitable item of mobile content has turned up as a search result. An example user interface displaying such search results is shown in FIG. 10. As shown the user interface is augmented with a “send as greeting” link associated with that item. The link is provided on a one-page summary of a search result but may alternatively be provided on a standard list of search results or on a list of search results which are a list of links to these richer one-page summaries of each search result rather than the destination site directly. Such summary pages or packages may be created as described in US 2007/00278329, US 2007/0067305 or US2007/0208704 to the present applicants. From the summary page, the user can decide whether to proceed to the destination site or continue with the looking at other results for the current search term. With this arrangement comes the possibility of using the summary page as the content for the greeting card as by definition, the summary has been created to be easily viewed on a mobile device. Alternatively, the item incorporated in the greeting can be simply a URL or other pointer to the content, or can be an extract of the content, or both. The extract can be of a size selectable by the user, can be text only, or include images, audio, video and so on, for example.

Once this is selected by a user, this link displays the content item and provides for the entering of whom the greeting is from together with an optional personalised message. The user can then send the content item to another person using either SMS, email or service-specific message.

To send as an SMS, the interface requests the user to enter the phone number of the recipient. The recipient is then sent an SMS containing the personalised message and a link to the main content item. Alternatively, the SMS contains only the sender's name and link to the card where both the personalised message and main content item can be viewed.

In another implementation of the SMS method, the service could render the content item together with the sender's name and message and then instruct the user to use the handset's native Send-Bookmark functionality to transmit the URL of the current page to another handset. This has the advantage that the user can use their addressbook to look up the number of the recipient. The implementation must then render that URL differently to the sender than it does to the recipient such that the sender sees a version with the instructions to use the native Send-Bookmark functionality and the recipient sees just the greeting card. The implementation can do this in several ways: by recognising the change in IP address, by rendering the page differently on the first access compared to subsequent accesses, or by cookie present on the senders handset.

To send the greeting as email, the user is prompted for an email address. The service then constructs an email and sends it on behalf of the user to the specified recipient's email address. The contents of the email can again be either the greeting card itself or a link to a page containing the card. Alternatively, as the recipient is likely to be receiving the email on a desktop email client (admittedly this likelihood is dropping with the increasing uptake of mobile email solutions), the email could contain a link to a page prompting the user to supply their phone number, which would then send an SMS to that number containing a link to the greeting card. Thereby providing a convenient means of viewing the greeting card on the recipients mobile.

As explained previously, a typical search engine “crawls” the Web and makes a copy of the information in a “web mirror” having an index of the keywords in the documents. The documents are ranked by various measures referred to as relevance, usefulness, or value measures. US 2007/0067304 entitled “Search using changes in prevalence of content items on the web” to the present applicant describes one method of ranking the documents. Statistics pertaining to the number of times a content item has been used in a greeting card can be used to adjust the ranking that content item is given in future searches. The more times a content item is used as a greeting card, the more likely it is that a future search is interested in that item.

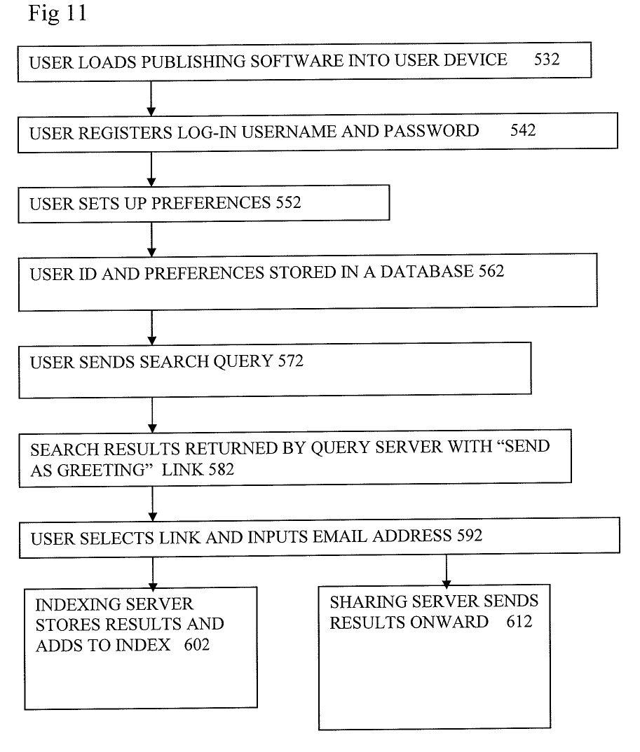

FIG. 11 summarises the main steps in this method of sharing results. At step 532, a user loads the publishing software into the user device (generally a mobile device). At a first stage, the user registers a log-in username and password (step 542) and creates his preferences, if any (step 552). The log-in information is stored in a database for later use by the sharing engine. After the initial set-up, the sharing engine prompts a user to log-in so that information relevant to that user may be accessed by the sharing engine. The user sends a search query (step 572) and the search results are returned by the query server with a send as greeting link (step 582). The user selects the link (step 592) and is prompted to enter an email address (or other information on the recipient). The sharing server sends the results to the appropriate target (step 612) using this entered information. The indexing server may also store the published search results and add them to the index (step 602).

In all of the above embodiments, a mobile device may be any kind of mobile computing device, including laptop and hand held computers, portable music players, portable multimedia players, mobile phones. Users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or microbrowser applications e.g. Openwave™, Access™, Opera™ Mozilla™ browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The summary page or package of screenviews which may be created as described in US 2007/00278329, US 2007/0067305 or US2007/0208704 can be implemented as a set of pages in XHTML Mobile Profile for example. As indicated by the W3C website, XHTML Mobile Profile is one in a series of XHTML specifications. The XHTML Mobile Profile document type includes the minimal set of modules required to be an XHTML Host Language document type, and in addition it includes images, forms, basic tables, and object support. It is designed for Web clients that do not support the full set of XHTML features; for example, Web clients such as mobile phones, PDAs, pagers, and settop boxes. The document type is rich enough for content authoring. XHTML Mobile Profile is designed as a common base that may be extended by additional modules from XHTML Modularization such as the Scripting Module. Thus it provides a common language supported by various kinds of user agents such as browsers. It is useful if the page format can be read and presented by many different versions of “legacy” browsers to maximize the user base among existing mobile telephone users for example.

The query server is typically connected to a database that stores detailed device profile information on mobile devices and desktop devices, including information on the device screen size, device capabilities and in particular the capabilities of the browser or microbrowser running on that device. The query server may be configured to detect the user agent identified in the HTTP headers contained in the request received from the mobile device's web browser. The server then adapts the package according to the model of mobile device.

The query server, and servers for indexing, calculating metrics and for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

Any of the additional features can be combined together and combined with any of the aspects. Other advantages will be apparent to those skilled in the art, especially over other prior art.

1. A system to provide a search service for finding and sharing online content, the system being arranged to
receive a search query from a user on a mobile device,
send search results to a user's mobile device,
prompt the user to select one or more items from the search results to be published, and
publish the selected item or items.

2. A system as claimed in claim 1, wherein the system is arranged to
prompt a user to configure at least one share link which is associated with at least one recipient with whom the user may wish to share a search item result,
store the at least one share link in a database in the system,
augment the sent search results with a list of share links to prompt a user to select at least one share link,
and publish the selected item or items to the at least one recipient associated with the selected share link.

3. A system as claimed in claim 2, wherein the system is arranged to change the format of a share link after it has been selected whereby the chance of repeat publication of the same result to the same recipient is reduced.

4. A system as claimed in claim 2, wherein the system is arranged to support multiple user accounts and to allow a user to configure a share link which is associated with another user account.

5. A system according to claim 1, wherein the system is arranged to publish the selected items to a user's private stream of results which is only visible to the user.

6. A system according to claim 1, wherein the system is arranged to publish the selected items to a user's public stream of results which is visible to any user.

7. A system as claimed in claim 1, wherein the system is arranged to prompt a user to nominate other users as friends.

8. A system as claimed in claim 7, wherein the system is arranged to publish the selected search item to a user's private stream of results so that it is available for only a user's nominated friends.

9. A system as claimed in claim 1, wherein the system is arranged to augment the search results sent to the user's mobile device with sending instructions explaining how to publish the selected search results to a third party recipient using the messaging function of the mobile device and wherein the system is arranged to publish the selected search results to the third party recipient without the sending instructions.

10. A system as claimed in claim 9, wherein the system augments each sent search results with a unique share link comprising a URL to the search result and a unique identifier and wherein the system is arranged to detect whether the combination of sent search results and unique share links are being viewed for a first time, and send the sending instructions if the system detects that the combination is being viewed for the first time.

11. A system as claimed in claim 10, wherein the system is arranged to associate a flag with the unique identifier after the combination has been viewed for a first time so that the sending instructions are not sent if the flag is detected.

12. A system as claimed in claim 10, wherein the system is arranged to detect whether or not the HTTP referrer is null and send the sending instructions only if the HTTP referrer is null.

13. A system as claimed in claim 10, wherein the system is arranged to detect the type of mobile device being used and display sending instructions associated with the detected type of mobile device.

14. A system as claimed in claim 1, wherein the system is arranged to publish the selected search item as an electronic greeting.

15. A system as claimed in claim 14, wherein the system is arranged to change the electronic greeting according to one or more of several factors including the time of year, the geographical location of the user and the language selected by the user.

16. A system as claimed in claim 1, wherein the system is arranged to prompt a user to provide a tag for the selected search item and the system is arranged to publish the selected search item with tag.

17. A system as claimed in claim 1, wherein the system is arranged to prompt a user to create user-generated content and the system is arranged to publish the user-generated content with the selected search item.

18. A system as claimed in claim 1, wherein the system is arranged to display search results in the form of summary pages and to display a prompt to a user to publish a selected search result on the summary page.

19. A method of providing a search service for finding and sharing online content, the method comprising
receiving a search query from a user on a mobile device,
sending search results to a user's mobile device,
prompting the user to select one or more items from the search results to be published, and
publishing the selected item or items.

20. A method of using a search service for finding and sharing online content, the method comprising
accessing search results provided by the search service,
interacting with the search service to select one or more items from the search result to be published, and
causing the search service to publish the selected item.

21. A system to provide a search service for finding and sharing online content, the system being arranged to
send search results to a user,
prompt the user to select one or more items from the search results, and
make the selected item or items publicly available as being recommended by the user.

22. A method of using a search service, the method comprising
sending a search query,
receiving search results,
selecting one or more items from the search results, and
causing the service to make the selected item or items publicly available as being recommended by the user.

23. A system to provide a search service for finding and sharing online content, the system being arranged to
send search results to a user,
prompt the user to select one or more items from the search results, and
make the selected item or items privately available.

24. A method of using a search service, the method comprising
sending a search query,
receiving search results,
selecting one or more items from the search results, and
causing the service to make the selected item or items privately available.

25. A system to provide a search service for finding online content, the system being arranged to
send search results to a user,
prompt the user to select one or more items from the search results, and
incorporate the selected item or items into an electronic greeting, for sending to another person.

26. A method of using a search service, the method comprising
sending a search query,
receiving search results,
selecting one or more items from the search results, and
causing the service to incorporate the selected items into an electronic greeting, and causing the electronic greeting to be sent to another person

27. A system to provide a search service for finding and sharing online content, the system being arranged to
receive a search query from a user on a mobile device,
detect whether or not the user has configured at least one share link which is associated with at least one recipient with whom the user may wish to share a search item result,
prompt a user to configure at least one share link if none are detected and store the at least one share link in a database in the system,
send search results to a user's mobile device with the search results being augmented with a list of share links to prompt a user to select at least one share link, and
send the selected item or items to the at least one recipient associated with the selected share link.

28. A method of using a search service for finding and sharing online content, the method comprising
sending a search query from a mobile device,
configuring, in response to a prompt from the search service, at least one share link which is associated with at least one recipient with whom a search item result may be shared,
receiving search results augmented with a list of share links,
selecting one or more items from the search results
selecting at least one share link, and
causing the search service to send the selected item or items to the at least one recipient associated with the selected share link.

29. A system to provide a search service for finding and sharing online content, the system being arranged to
receive a search query from a user on a mobile device,
send search results to a user's mobile device,
prompt the user to select one or more items from the search results,
send to the user sending instructions explaining how to send the selected search item to a third party recipient using the messaging function of the mobile device, and
send the selected item or items to the third party recipient without the sending instructions.

30. A program on a computer readable medium arranged to carry out the method of claim 19.
